(19) United States
(12) Patent Application Publication
(10) Pub. No.: US 2017/0143006 A1
(43) Pub. Date: May 25, 2017

(54) Composition and Use Thereof

(71) Applicant: DUPONT NUTRITION BIOSCIENCES APS, Copenhangen K (DK)

(72) Inventors: Ajay Awati, Swindon (GB); Kathryn Louise Tse, Valby (DK); Stephane Frouel, Paris (FR); Rafael Duran Gimenez-Rico, Madrid (ES); Tracey Sainsbury, Highworth (GB)

(73) Assignee: DUPONT NUTRITION BIOSCIENCES APS, Copenhangen K (DK)

(21) Appl. No.: 15/320,263

(22) PCT Filed: Jun. 24, 2015
(86) PCT No.: PCT/EP2015/064296

§ 371 Date: Dec. 19, 2016

(30) Foreign Application Priority Data
Jun. 24, 2014 (GB) 1411197.5

(51) Int. Cl. A23K 50/10; A23K 20/10; A23K 20/142; A23K 40/35; A23K 20/163; A23K 20/174; A23K 20/189; A23K 20/20; A23K 10/18; A23K 20/158

(52) U.S. Cl. CPC A23K 50/10; A23K 10/18; A23K 20/10; A23K 20/142; A23K 20/158; A23K 20/163; A23K 20/174; A23K 20/189; A23K 20/20; A23K 40/35

(57) ABSTRACT

The present invention relates to a composition comprising a feed or feed additive and a coating substance, wherein the feed or feed additive is coated with the coating substance, wherein the coating substance decreases the degree of degradation of the feed or feed additive within the rumen environment. Furthermore, the present invention relates to the use of said compositions for increasing feed utilization, improving animal nutrition, milk production and reducing global warming.

### FIELD OF THE INVENTION

The present invention relates to a composition and its use in ruminant nutrition.

In particular, the present invention relates to a composition for decreasing the degree of degradation of a feed or a feed additive within the rumen environment and uses thereof. Furthermore, the present invention also relates to a composition which is advantageous as a component of an animal feed composition, and an animal feed composition comprising said composition.

### BACKGROUND OF THE INVENTION

A ruminant is a mammal of the order Artiodactyla that digests plant-based food by initially softening it within the animal's first stomach chamber, then regurgitating the semi-digested mass, now known as cud, and chewing it again. The process of rechewing the cud to further break down plant matter and stimulate digestion is called “ruminating.” Ruminants have a stomach with four chambers, namely the rumen, reticulum, omasum and abomasum. In the first two chambers, the rumen and the reticulum, the food is mixed with saliva and separates into layers of solid and liquid material. Solids clump together to form the cud, or bolus. The cud is then regurgitated, chewed slowly to completely mix it with saliva, which further breaks down fibers. Fiber, especially cellulose, is broken down into glucose in these chambers by commensal bacteria, protozoa and fungi. The broken-down fiber, which is now in the liquid part of the contents, then passes through the rumen into the next stomach chamber, the omasum, where water is removed. The food in the abomasum is digested much like it would be in the human stomach. It is finally sent to the small intestine, where the absorption of the nutrients occurs.

In ruminant nutrition it is a challenge to bypass the rumen successfully to allow the feed or feed additives to reach the preferred site, which is often lower down the GI tract e.g. small intestine. Often the feed or feed additives used are degraded in the rumen environment which results in either loss of form or activity of the feed or feed additive. Therefore, larger quantities of feed and feed additives are often used to compensate, thus adding to the costs of ruminant nutrition.

### SUMMARY OF INVENTION

The present invention aims to increase feed utilization, improve animal nutrition, milk production and reduce global warming.

In a first aspect, the present invention relates to a composition comprising a feed or feed additive and a coating substance, wherein the feed or feed additive is coated with the coating substance selected from hardened vegetable fats and oils, fatty acid monoglycerides, diglycerides and triglycerides, free fatty acids, waxes, natural and synthetic resins, polymers, emulsifiers and mixtures thereof, and wherein the coating substance decreases the degree of degradation of the feed or feed additive within the rumen environment.

In a second aspect, the present invention relates to the use of a composition as defined herein for reducing the degree of degradation of the feed or feed additive within the rumen environment.

In a third aspect, the present invention relates to the use of a composition as defined herein for improving milk yield in lactating ruminants.

In a fourth aspect, the present invention relates to the use of a composition comprising a feed or feed additive and a coating substance, wherein the feed or feed additive is coated with the coating substance, for reducing methane production by ruminants.

In a fifth aspect, the present invention relates to the use of a composition comprising a feed or feed additive and a coating substance, wherein the feed or feed additive is coated with the coating substance, for reducing global warming.

In a sixth aspect, the present invention relates to a method for reducing the degree of degradation of a feed or feed additive in the rumen environment comprising administering a composition as described herein to ruminants.

In a seventh aspect, the present invention relates a method for improving the milk yield of ruminants comprising administering a composition as described herein to lactating ruminants.

In an eighth aspect, the present invention relates to a method for reducing global warming comprising administering a composition as described herein to ruminants.

In a ninth aspect, the present invention relates to a feed or feed additive wherein the feed or feed additive is coated with a coating substance wherein the coating substance comprises microlayers of a hardened fat.

In a tenth aspect, the present invention relates to a coated feed or feed additive obtainable by a process comprising hot melt coating a feed additive with a hardened fat.

In an eleventh aspect, the present invention relates to an animal feed composition comprising a composition as described herein.

### BRIEF DESCRIPTION OF FIGURES

FIG. 1 represents methane production after incubating animal feed compositions comprising various samples of coated and uncoated betaine in ruminal fluid for 24 hours.

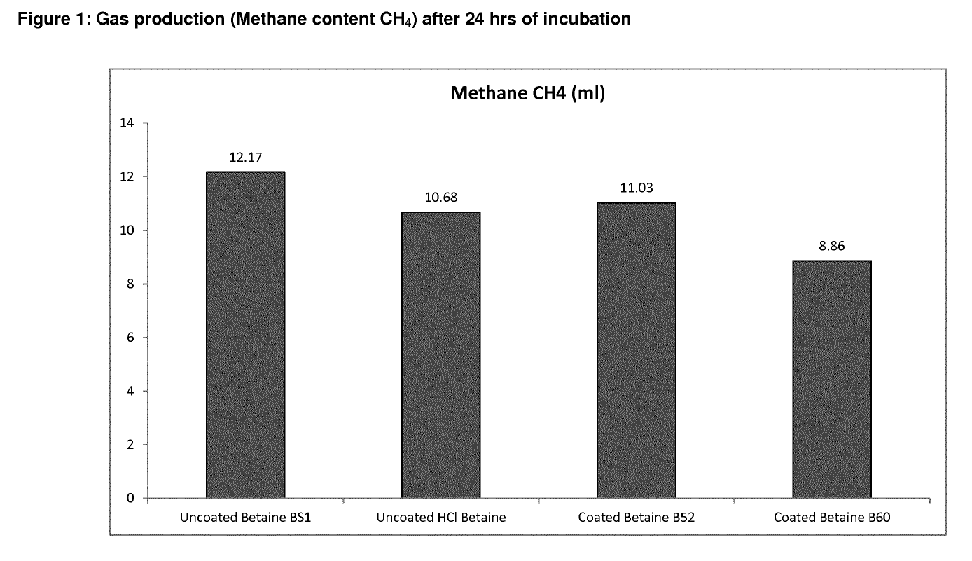

FIG. 2 represents ammonia production after incubating animal feed compositions comprising various samples of coated and uncoated betaine in ruminal fluid for 24 hours.

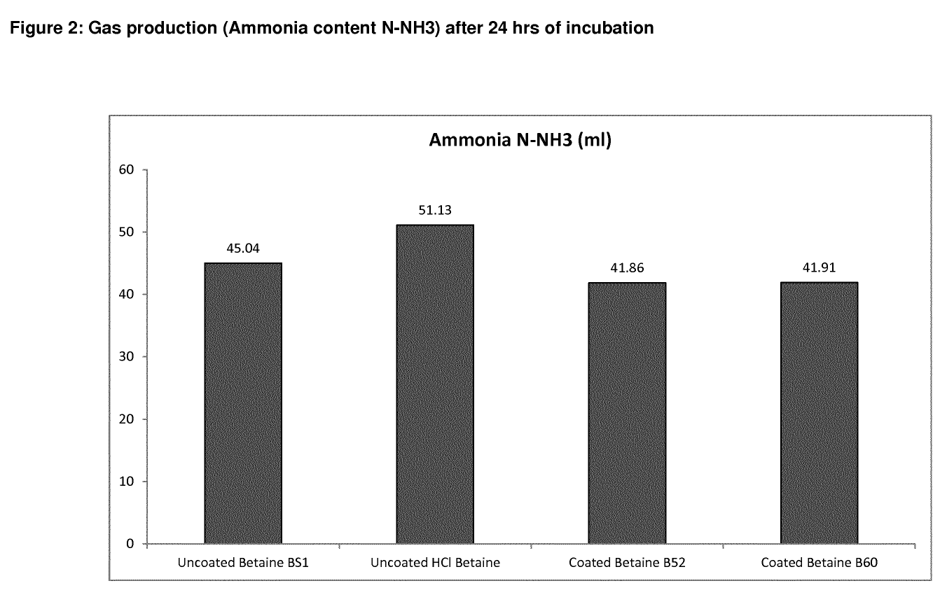

FIG. 3 represents butyric acid production after incubating animal feed compositions comprising various samples of coated and uncoated betaine in ruminal fluid for 24 hours.

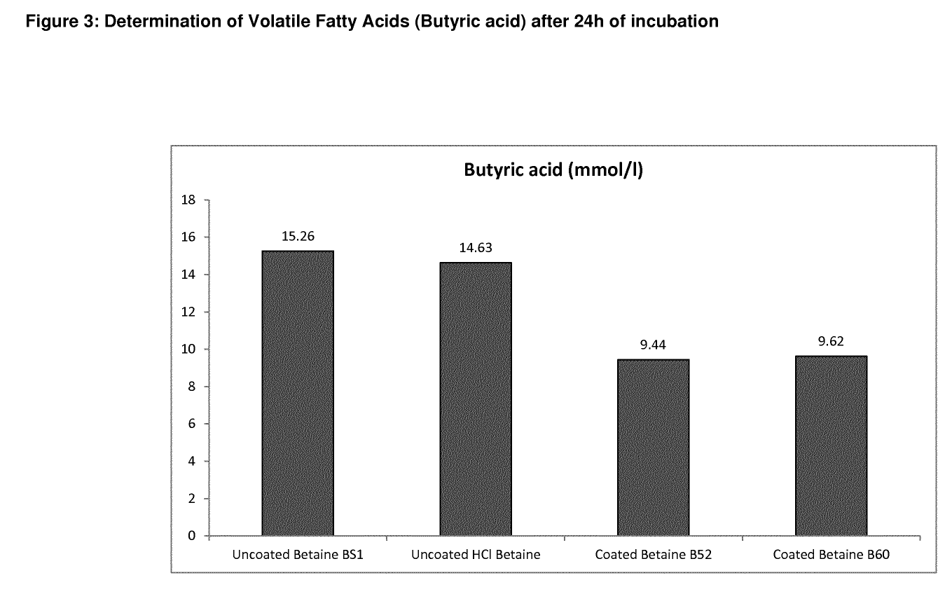

FIG. 4 represents propionic acid production after incubating animal feed compositions comprising various samples of coated and uncoated betaine in ruminal fluid for 24 hours.

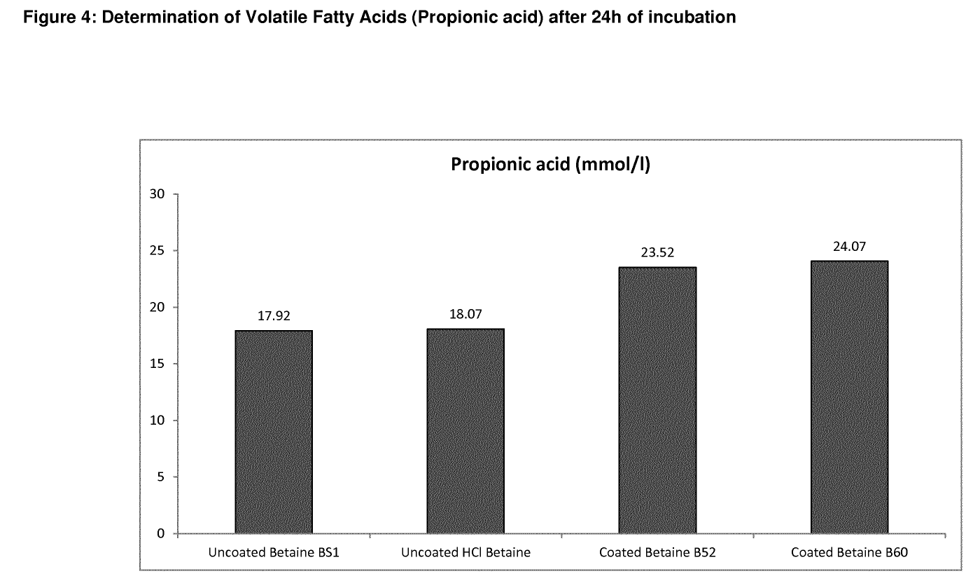

### DETAILED DESCRIPTION OF THE INVENTION

In one aspect, the present invention relates to a composition comprising a feed or feed additive and a coating substance, wherein the feed or feed additive is coated with the coating substance selected from hardened vegetable fats and oils, fatty acid monoglycerides, diglycerides and triglycerides, free fatty acids, waxes, natural and synthetic resins, polymers, emulsifiers and mixtures thereof, and wherein the coating substance decreases the degree of degradation of the feed or feed additive within the rumen environment.

In another aspect, the present invention relates to the use of a composition as defined herein for reducing degradation of the feed or feed additive within the rumen environment.

In another aspect, the present invention relates to the use of a coating substance as defined herein for reducing degradation of the feed or feed additive within the rumen environment.

In another aspect, the present invention relates to a method for reducing the degree of degradation of a feed or feed additive in the rumen environment comprising administering a composition as described herein to ruminants.

In one embodiment, a decrease in the degree of degradation of the feed or feed additive may be determined by incubating the feed or feed additive with ruminal fluid and observing the change in mass of the feed or feed additive. A difference observed in the mass of residual feed or feed additive between comparable samples containing either coated or uncoated feed or feed additive may be used to show the effect which coating with a coating substance has on the degree of degradation of the feed or feed additive within the rumen environment.

In another embodiment, a decrease in the degree of degradation of the feed or feed additive may be determined by incubating the feed or feed additive with ruminal fluid and observing the change in mass, on a dry matter basis, of the initial feed or feed additive at the start of the incubation to the residual mass of the feed or feed additive, on a dry matter basis, at the end of the incubation. A difference observed in the dry mass of residual feed or feed additive between comparable samples containing either coated or uncoated feed or feed additive may be used to show the effect which coating with a coating substance has on the degree of degradation of the feed or feed additive within the rumen environment.

In one embodiment, a decrease in the degree of degradation of the feed or feed additive may be determined by incubating the feed or feed additive with ruminal fluid and observing the fermentation product profile. A difference in fermentation product profile between comparable samples containing either coated or uncoated feed or feed additive may be used to show the effect coating with a coating substance has on the degree of degradation of the feed or feed additive within the rumen environment.

As used herein, ‘fermentation product profile’ refers to the quantities of substances evolved when an animal feed composition comprising the feed or feed additive of the invention is incubated with ruminal fluid. These substances may include gases, such as methane and carbon dioxide, volatile fatty acids, such as short chain fatty acids (e.g. propionic acid and butyric acid) and branched chain fatty acids, and other substances such as ammonia, and amines etc.

In one embodiment, a decrease in the degree of degradation of the feed or feed additive may be determined by incubating the feed or feed additive with ruminal fluid and observing the production of methane gas.

In another embodiment, a decrease in the degree of degradation of the feed or feed additive may be determine by incubating the feed or feed additive with ruminal fluid and observing the production of volatile fatty acids, in particular propionic acid and/or butyric acid.

In one embodiment, a decrease in the degree of degradation and/or fermentation product profile is determinable by the following method (herein referred to as “assay method”):

Filtered ruminal fluid is mixed with Goering and Van Soest (1970) buffer solution in a 1:4 (v/v) ratio at 39° C. under a continuous flow of CO₂. A sample of an animal feed composition comprising the feed or feed additive of the invention (1 g) is added to 50 ml of the buffered ruminal fluid and bottled under CO₂ flow. The bottles are sealed and incubated at 39° C. for 24 hours. Analysis of the residue is performed after 24 hours of incubation, and volatile fatty acids (VFA) and gas samples are taken after 24 hours of incubation.

The gas content can be analysed in a Focus Gas Chromatograph (Thermo, Milan, Italy) equipped with a split/splitless injector and a flame ionization detector. The separation can be performed in a GS-Q capillary column (J&W Scientific, USA) (30 m×0.32 mm i.d.). The carrier gas may be Helium at a constant flow of 1 ml/min. The samples may be injected with a split ratio of 1/100. The initial oven temperature can be set at 50° C. held for 1 min and increased to 150 at 50° C./min and finally maintained at that temperature for 2 min. Both detector and injector temperatures can be set at 200° C. An external standard (41.21% CO₂ and 58.79% CH₄) may be employed for quantification of methane content in samples.

Determination of VFA can be based on the method previously described by Jouany, J. P., Volatile fatty acid and alcohol determination in digestive contents, silage juices, bacterial cultures and anaerobic fermentor contents; Sciences des Aliments, 2: 131-144, 1982.

For instance, samples are filtered through 0.45 μm cellulose syringe filters. One hundred microliters of an internal standard solution (0.4 g of 4-metil-valeric acid diluted in 100 ml of deionised water) and 0.1 ml of a preservative (a mix of 5% H₃PO₄ and 1% CIHg in deionised water) are added to 0.8 ml of filtrate. One μL from each sample is injected in a gas chromatograph (Fisons 8000 series, Milan, Italy) equipped with a split/splitless injector and FID detector. The separation of SOFA (short chain fatty acids) is made in a DB-FFAP capillary column (30 m×0.25 mm×0.25 μm of film thickness) J&W Scientific (USA). The carrier gas is N₂ at a constant pressure of 120 KPa. Both detector and injector temperatures are set at 245° C. The initial oven temperature is set at 115° C. held for 5 min and increased to 230 at 8.5° C./min and finally maintained at that temperature for 10 min. SOFA are identified by comparing their retention times with a standard (46975-U de Supelco®, PA, USA).

A decrease in the degree of degradation can be observed by performing a comparative study with an analogous sample containing uncoated feed or feed additive.

A difference in the residual mass of the feed or feed additive, or a change in the fermentation end product, either gases or VFAs, means the accessibility of the feed or feed additive to rumen microbial population was altered, suggesting an ability of the coating to stay intact longer in rumen environment.

Preferably, an increase in the residual (dry) mass of the feed or feed additive is observed.

Preferably a decrease in the amount of methane produced per gram of sample (dry weight) is observed.

Preferably an increase in the amount of propionic acid produced per gram of sample (dry weight) is observed.

Preferably a decrease in the amount of butyric acid produced per gram of sample (dry weight) is observed.

In one embodiment, the degree of degradation is decreased such that there is at least a 5% increase in the amount of residual feed or feed additive per gram of initial feed or feed additive (calculated on a dry matter basis). Preferably, an increase of at least about 6%. More preferably, an increase of at least about 7%. More preferably, an increase of at least about 8%. More preferably, an increase of at least about 9%. More preferably, an increase of at least about 10%.

In one embodiment, the degree of degradation is decreased such that there is up to a 5% increase in the amount of residual feed or feed additive per gram of initial feed or feed additive (calculated on a dry matter basis). Preferably, an increase of up to about 6%. More preferably, an increase of up to about 7%. More preferably, an increase up to about 8%. More preferably, an increase of up to about 9%. More preferably, an increase of up to about 10%.

In one embodiment, the degree of degradation is decreased such that there is between about 1% and about 30% increase in the amount of residual feed or feed additive per gram of initial feed or feed additive (calculated on a dry matter basis). Preferably, an increase of between about 1% and about 25%. More preferably, an increase of between about 1% and about 10%. More preferably, an increase of between about 5% and about 15%. More preferably, an increase of between about 5% and about 10%.

In one embodiment, the degree of degradation is decreased such that there is at least a 5% decrease in the amount of CH₄ produced within 24 hours per gram of feed or feed additive (dry matter basis). Preferably, a decrease of at least about 10%. More preferably, a decrease of at least about 15%. More preferably, a decrease of at least about 20%. More preferably, a decrease of at least about 25%.

In one embodiment, the degree of degradation is decreased such that there is up to a 5% decrease in the amount of CH₄ produced within 24 hours per gram of feed or feed additive (dry matter basis). Preferably, a decrease of up to about 10%. More preferably, a decrease of up to about 15%. More preferably, a decrease of up to about 20%. More preferably, a decrease of up to about 25%.

In one embodiment, the degree of degradation is decreased such that there is a decrease in the amount of CH₄ produced within 24 hours per gram of feed or feed additive (dry matter basis) of between 1 and 30%. More preferably, between 5 and 35%. More preferably, between 10 and 30%.

In one embodiment, the degree of degradation is decreased such that there is at least a 5% increase in the amount of propionic acid produced within 24 hours per gram of feed or feed additive (dry matter basis). Preferably, an increase of at least about 10%. More preferably, an increase of at least about 15%. More preferably, an increase of at least about 20%. More preferably, an increase of at least about 25%. More preferably, an increase of at least about 30%. More preferably, an increase of at least about 35%. More preferably, an increase of at least about 40%.

In one embodiment, the degree of degradation is decreased such that there is up to a 30% increase in the amount of propionic acid produced within 24 hours per gram of feed or feed additive (dry matter basis). Preferably, an increase of up to about 35%. More preferably, an increase of up to about 40%.

In one embodiment, the degree of degradation is decreased such that there is an increase in the amount of propionic acid produced within 24 hours per gram of feed or feed additive (dry matter basis) of between 1 and 40%. More preferably, between 5 and 40%. More preferably, between 10 and 40%. More preferably, between 20 and 40%. More preferably, between 30 and 40%. More preferably, between 30 and 35%.

In one embodiment, each of the above decreases in degradation may be determined by sealing 1 g (dry weight) of an animal feed composition comprising the feed or feed additive of the invention (1.5% betaine) in a bottle of 1:4 goat ruminal fluid:Goering and Van Soest (1970) buffer solution and incubating at 39° C. for 24 hours.

In one embodiment, a decrease in the amount of degradation, an increase in the residual dry mass of the feed or feed additive, a decrease in the amount of methane, an increase in the amount of propionic acid and/or a decrease in the amount of butyric acid is determinable by the assay method referred to above.

As used herein the term ‘ruminant’ refers to the members of the Ruminantia and Tylopoda suborders.

In one embodiment, the ruminant animal can be selected from the members of the Antilocapridae, Bovidae, Cervidae, Giraffidae, Moschidae, Tragulidae families.

In another embodiment, the ruminant animal can be a cow, goat, sheep, giraffe, bison, yak, water buffalo, deer, camel, alpaca, llama, wildebeest, antelope, pronghorn or nilgai.

In another embodiment, the ruminant is selected from cattle, sheep, goats and buffalo.

As used herein, the term ‘rumen environment’ refers to the conditions within the rumen.

In general, the rumen has a temperature of about 39° C. and a pH in the range of 5 to 7, and is colonized by microbes. As the environment inside a rumen is anaerobic, most microbial species are obligate or facultative anaerobes that can decompose complex plant material, such as cellulose, hemicellulose, starch, and proteins. The hydrolysis of cellulose results in sugars, which are further fermented to acetate, lactate, propionate, butyrate, carbon dioxide and methane. In one embodiment, degradation of feed or feed additives is primarily due to the action of rumen microbes present in the rumen environment.

In one embodiment, the rumen environment is that of the rumen of cattle, goat, sheep, giraffe, bison, yak, water buffalo, deer, camel, alpaca, llama, wildebeest, antelope, pronghorn or nilgai. Preferably, the rumen environment is that of cattle, goats, sheep or buffalo. More preferably, the rumen environment is that of goats or cattle.

In one embodiment, the rumen environment is that of goats.

In one embodiment, the rumen is that of cattle.

As used herein, the term ‘ruminal fluid’ refers the digestive fluid of a ruminant which may be obtained by inserting an oesophagus probe into a rumen.

In one embodiment, the ruminal fluid is obtained from the rumen of cattle, goats, sheep or buffalo. In a preferred embodiment the ruminal fluid is obtained from goats or cattle.

In one embodiment, the ruminal fluid is obtained from goats.

In one embodiment, the ruminal fluid is obtained from cattle.

In one embodiment, the ruminal fluid comprises rumen microbes.

In one embodiment, the composition of the present claims is for oral administration to ruminants. Preferably, the composition is included as a component of an animal feed composition.

### Feed or Feed Additive

As used herein, the term ‘feed’ refers to a substance which provides nutritional value to an animal, preferably a ruminant.

As used herein, the term ‘feed additive’ refers to a substance which is added to a feed. Feed additives may be added to feed for a number of reasons. For instance, to enhance digestibility of the feed, to supplement the nutritional value of the feed, improve the immune defence of the recipient and/or to improve the shelf life of the feed. Preferably, the feed additive supplements the nutritional value of the feed and/or improves the immune defence of the recipient.

In one embodiment, a feed additive may also be considered a feed.

In one embodiment, the feed or feed additive is selected from betaine, direct fed microbials, enzymes, essential oils, organic acids, vitamins, amino acids, minerals.

As used herein the term “direct fed microbials” refers to a live microbial feed supplement which beneficially affects the host by improving its intestinal microbial balance.

In one embodiment, a direct fed microbial may utilize one or more types of bacteria, and/or yeast, and/or fungi. In one embodiment, the direct fed microbials comprise one or more types of bacteria. In one embodiment, the bacteria are selected from one or more of L. lactis, L. plantarum, L. casei, Bacillus subtilis, B. lichenformis, Enterococcus faecium, Bifidobacterium bifidum, B. longum, and B. thermophilum.

Feed enzymes may be selected from phytase feed enzymes, carbohydrase feed enzymes and protease feed enzymes and mixtures thereof.

In one embodiment, the feed or feed additive comprises betaine or an animal feed acceptable salt or hydrate thereof.

In one embodiment, the feed or feed additive essentially consists of betaine or an animal feed acceptable salt or hydrate thereof.

In one embodiment, the feed or feed additive consists of betaine or an animal feed acceptable salt or hydrate thereof.

As used herein the term “betaine” refers to trimethylglycine. The compound is also called trimethylammonioacetate, 1-carboxy-N,N,N-trimethylmethaneaminium, inner salt and glycine betaine. It is a naturally occurring quaternary ammonium type compound having the formula

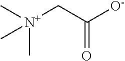

Betaine has a bipolar structure comprising a hydrophilic moiety (COO⁻) and a hydrophobic moiety (N⁺) capable of neutralizing both acid and alkaline solutions. In its pure form, betaine is a white crystalline compound that is readily soluble in water and lower alcohols.

In the present invention betaine can be used, for example, as an anhydrous form, or as a hydrate or as an animal feed acceptable salt.

As used herein an “animal feed acceptable salt” means any non-toxic salt that, upon administration to a recipient, is capable of providing, either directly or indirectly, a compound or a derivative of a compound of this invention. Acids commonly employed to form acceptable salts include inorganic acids such as hydrogen bisulfide, hydrochloric, hydrobromic, hydroiodic, sulfuric and phosphoric acid, as well as organic acids such as para-toluenesulfonic, salicylic, tartaric, bitartaric, ascorbic, maleic, besylic, fumaric, gluconic, glucuronic, formic, glutamic, methanesulfonic, ethanesulfonic, benzenesulfonic, lactic, oxalic, para-bromophenylsulfonic, carbonic, succinic, citric, benzoic and acetic acid, and related inorganic and organic acids. Such animal feed acceptable salts thus include sulfate, pyrosulfate, bisulfate, sulfite, bisulfite, phosphate, monohydrogenphosphate, dihydrogenphosphate, metaphosphate, pyrophosphate, chloride, bromide, iodide, acetate, propionate, decanoate, caprylate, acrylate, formate, isobutyrate, caprate, heptanoate, propiolate, oxalate, malonate, succinate, suberate, sebacate, fumarate, maleate, butyne-1,4-dioate, hexyne-1,6-dioate, benzoate, chlorobenzoate, methylbenzoate, di nitrobenzoate, hydroxybenzoate, methoxybenzoate, phthalate, terephathalate, sulfonate, xylenesulfonate, phenylacetate, phenylpropionate, phenylbutyrate, citrate, lactate, [beta]-hydroxybutyrate, glycolate, maleate, tartrate, methanesulfonate, propanesulfonate, naphthalene-1-sulfonate, naphthalene-2-sulfonate, mandelate and the like salts. Preferred animal feed acceptable acid addition salts include those formed with mineral acids such as hydrochloric acid and hydrobromic acid, and those formed with organic acids such as maleic acid.

Suitable cations for forming feed acceptable salts include ammonium, sodium, potassium, calcium, magnesium and aluminium cations, among others.

In one embodiment, when betaine is present, it is present as the free zwitterion.

In one embodiment, when betaine is present, it is present as anhydrous betaine.

In one embodiment, when betaine is present, it is present as a monohydrate.

Betaine is commercially available from Finnfeeds Finland Oy as an anhydrous form and also as a monohydrate.

### Coating Substance

In one embodiment, the coating substance decreases the degree of degradation of the feed or feed additive in the rumen environment.

In one embodiment, the coating substance comprises a lipid, an emulsifier or a polymer. In another embodiment, the coating substance comprises a lipid or a polymer. In another embodiment, the coating substance comprises a lipid.

In one embodiment, the coating substance consists essentially of a lipid, an emulsifier or a polymer. In another embodiment, the coating substance consists essentially of a lipid or a polymer. In another embodiment, the coating substance consists essentially of a lipid.

In one embodiment, the coating substance consists of a lipid, an emulsifier or a polymer. In another embodiment, the coating substance consists of a lipid or a polymer. In another embodiment, the coating substance consists of a lipid.

In one embodiment, the emulsifier is selected from fatty acid monoglycerides, diglycerides, polyglycerol esters and sorbitan esters of fatty acids.

In one embodiment, the lipid is selected from animal oils or fats, vegetable oils or fats, triglycerides, free fatty acids, animal waxes, (such as beeswax, lanolin, shell wax or Chinese insect wax), vegetable waxes (such as carnauba, candelilla, bayberry or sugarcane), mineral waxes, synthetic waxes, natural and synthetic resins and mixtures thereof.

In another embodiment, the lipid is selected from animal oils or fats, vegetable oils or fats, triglycerides, vegetable waxes (such as carnauba, candelilla, bayberry or sugarcane), mineral waxes, synthetic waxes, natural and synthetic resins and mixtures thereof.

In another embodiment, the lipid is selected from hardened vegetable oils or fats, triglycerides, and mixtures thereof.

Preferably the lipid is a fat, preferably a vegetable-derived fat.

Preferably the fat is solid at room temperature. More preferably the fat has a melting point of about 40° C. or more. More preferably the fat has a melting point of about 50° C. or more. More preferably the fat has a melting point of about 60° C. or more.

In one embodiment, the fat has a melting point of about 40° C. to about 80° C., preferably the fat has a melting point of about 50° C. to about 80° C., preferably the fat has a melting point of about 55° C. to about 75° C., preferably the fat has a melting point of about 55° C. to about 70° C.

Preferably the fat is a hardened fat, more preferably a fully hardened fat.

In another embodiment, the coating substance comprises a lipid selected from a hardened fat, more preferably a fully hardened fat.

The term “hardened fat” or “hydrogenated fat” is fat that has been exposed to a hydrogenation process (Ullmann's Encyclopaedia of Industrial Chemistry, Sixth Edition, Fats and Fatty Oils, 4.3 and 8). Typically, the fat is subjected to catalytic hydrogenation in the presence of a transition metal catalyst, for example, a nickel, palladium or platinum catalyst.

Fully hardened fat is defined as a fat having an Iodine Value (IV) of less than 5, where the iodine value is measured by the conventional IUPAC technique (International Union of Pure and Applied Chemistry (IUPAC), Standard Method for the Analysis of Oils, Fats and Derivatives, Method 2.205).

Preferably, the fats are free fatty acids (such as stearic acid, palmitic acid and oleic acid) or derivatives of fatty acids and glycerol. More preferably, the fats are comprised of triglycerides.

The term “triglyceride” preferably means a triester of glycerol and a fatty acid.

Preferably, the triglyceride is a triester of glycerol, and a C₄ to C₂₄ fatty acid.

More preferably, the triglyceride is selected from triglycerides having a fatty acid chain length of 10 carbons or more; more preferably, 14 carbons or more; or mixtures thereof.

Preferably, the triglyceride is selected from triglycerides having a fatty acid chain length of 10 to 20 carbons, more preferably 14 to 18 carbons; or mixtures thereof.

In a preferred embodiment, the fat comprises triglycerides having a C14, C16 and C18 fatty acid chain length, and mixtures thereof.

Preferably the fatty acid of the triglyceride is saturated.

In another embodiment, the coating substance comprises, essentially consists or consists of a fat selected from canola oil, cottonseed oil, peanut oil, corn oil, olive oil, soybean oil, sunflower oil, safflower oil, coconut oil, palm oil, linseed oil, tung oil, castor oil and rapeseed oil.

Preferably, the coating substance comprises, essentially consists or consists of a fat selected from hardened canola oil, hardened cottonseed oil, hardened peanut oil, hardened corn oil, hardened olive oil, hardened soybean oil, hardened sunflower oil, hardened safflower oil, hardened coconut oil, hardened palm oil, hardened linseed oil, hardened tung oil, hardened castor oil, and hardened rapeseed oil.

Preferably, the coating substance comprises, essentially consists or consists of a fat selected from fully hardened canola oil, hardened cottonseed oil, fully hardened peanut oil, fully hardened corn oil, fully hardened olive oil, fully hardened soybean oil, fully hardened sunflower oil, fully hardened safflower oil, fully hardened coconut oil, fully hardened palm oil, fully hardened linseed oil, fully hardened tung oil, fully hardened castor oil, and fully hardened rapeseed oil.

In another embodiment, the coating substance consists essentially of a fat selected from palm oil, rapeseed oil, cottonseed oil and soybean oil; preferably, hardened palm oil, hardened rapeseed oil, hardened cottonseed oil and hardened soybean oil; more preferably, fully hardened palm oil, fully hardened rapeseed oil, fully hardened cottonseed oil and fully hardened soybean oil.

In another embodiment, the coating substance comprises a polymer selected for one or more of film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixture thereof.

In another embodiment, the coating substance comprises a polymer selected from water soluble polymers (such as polyvinylalcohol), or a film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixture thereof.

In one embodiment, the coating substance comprises a polymer selected from one or more of ethylcellulose, hydroxyethylcellulose, hydroxypropylcellulose, carrageenan and sodium alginate.

In one embodiment, the coating substance comprises a polymer selected from one or more of ethylcellulose, hydroxyethylcellulose, hydroxypropylcellulose, polyvinylalcohol, carrageenan and sodium alginate.

In one embodiment, the polymer is feed grade polymer with a slow rate of aqueous solubility, for example, a polyvinylalcohol. The rate of solubility of polyvinylalcohol can be adjusted by changing the degree of hydrolysis or the molecular weight of the polymer. Increasing either will slow the rate of solubility in water.

Examples of polyvinylalcohols with a high degree of hydrolysis (e.g. fully hydrolysed) are Poval 4-98 (from Kuraray) and SELVOL E103 (from Seiksui). Examples of polyvinylalcohol grades with high molecular weight are Mowial 18-88 (from Kuraray) and SELVOL 107 (from Seiksui).

In one embodiment, the polymer is a fully hydrolysed polyvinylalcohol. In one embodiment, the fully hydrolysed polyvinylalcohol is greater than about 98% hydrolysed. In another embodiment, the fully hydrolysed polyvinylalcohol is about 98% to about 99% hydrolysed.

In one embodiment, the polymer is a high molecular weight polyvinylalcohol. In one embodiment, the number or mass average molecular weight is greater than about 100,000. In another embodiment, the number or mass average molecular weight is greater than about 110,000. In another embodiment, the number or mass average molecular weight is greater than about 120,000. In another embodiment, the number or mass average molecular weight is greater than about 130,000.

In one embodiment, the number or mass average molecular weight is about 100,000 to about 200,000. In one embodiment, the number or mass average molecular weight is about 110,000 to about 190,000. In one embodiment, the number or mass average molecular weight is about 120,000 to about 190,000. In one embodiment, the number or mass average molecular weight is about 130,000 to about 190,000. In one embodiment, the number or mass average molecular weight is about 130,000 to about 170,000. In one embodiment, the number or mass average molecular weight is about 130,000 to about 150,000.

In one embodiment the number or mass average weight is about 131,000.

In one embodiment, the polymer is high molecular weight and fully hydrolysed polyvinylalcohol. More specifically, the polymer is a high molecular weight and fully hydrolysed polyvinylalcohol as defined above,

In another embodiment, the coating substance comprises one or more of the following: ethylcellulose, HMPC, carageenan, sodium alginate, fully hardened palm oil, fully hardened rapeseed oil, fully hardened cottonseed oil and fully hardened soybean oil.

In another embodiment, the coating substance comprises one or more of the following: ethylcellulose, HMPC, polyvinylalcohol, carageenan, sodium alginate, fully hardened palm oil, fully hardened rapeseed oil, fully hardened cottonseed oil and fully hardened soybean oil.

In another embodiment, the coating substance may further comprise other ingredients, such as inert fillers (e.g. calcium hydrogen phosphate).

In one embodiment, the feed or feed additive is coated wherein the feed or feed additive is encapsulated within a cross-linked aqueous hydrocolloid droplet which itself is encapsulated in a solid fat droplet.

In another embodiment, the feed or feed additive is coated with microlayers of a lipid, preferably the lipid is as described above.

In another embodiment, the feed or feed additive is coated wherein the feed or feed additive is suspended as a dispersed phase within a polymer continuous phase, preferably the polymer is as described above.

In another embodiment, the feed or feed additive is coated wherein the feed or feed additive and coating substance form a core, and the core is encapsulated with a further coating substance.

In another embodiment, the feed or feed additive is coated wherein the feed or feed additive is dispersed within a lipid (e.g. by spray-cooling), preferably the lipid is as described above. The resultant coated feed or feed additive forms a core, which is then itself coated (e.g. by hot melt coating) with a layer of lipid to form an encapsulated core. Preferably, the lipid comprises a fat as defined above. More preferably, the lipid is fully hardened palm oil, fully hardened rapeseed oil, fully hardened cottonseed oil or fully hardened soybean oil.

In one embodiment, the feed or feed additive is coated with hardened palm oil, preferably microlayers of hardened palm oil. In another embodiment, the feed or feed additive is coated with fully hardened palm oil, preferably microlayers of fully hardened palm oil.

In another embodiment, the feed or feed additive is coated with ethylcellulose and plasticizer. Preferably the plasticizer is selected from acetic acid esters of mono- and di-glycerides of fatty acids.

In another embodiment, the feed or feed additive is coated (entrapped) inside alginate beads which are further incorporated inside solid lipid beads.

As used herein, the term ‘coated’ may refer to covering the surface of the feed or feed additive with a coating substance. Preferably substantially all of the surface area of the feed or feed additive is coated. More preferably, all of the surface area of the hydro-soluble component is coated. More preferably, all of the surface area of the feed or feed additive is coated.

In one embodiment, the term ‘coated’ may refer to covering, encapsulation, suspension or entrapment of the feed or feed additive with/within the coating substance.

In one embodiment, the feed or feed additive is covered with the coating substance, preferably completely covered.

In another embodiment, the feed or feed additive is suspended in the coating substance.

In another embodiment, the feed or feed additive is entrapped in the coating substance.

In another embodiment, the feed or feed additive is encapsulated in the coating substance.

### Composition

In another aspect, the present invention relates to a composition comprising a feed or feed additive coated with a coating substance wherein the coating substance comprises microlayers of hardened fat. The coating itself is composed of multiple layers. Each layer is not continuous, but they overlap, thus building up a micro-layered structure (layers approximately 1 μm or less) analogous to a brick wall. This overlapping, layered structure creates a tortuous path for the water to diffuse along, thus greatly reducing the solubility rate of the coated composition.

As used herein, “microlayers” refers to layers of coating material about one micron thick or less. Preferably, a multitude of microlayers are provided.

In one embodiment, the coating itself is composed of multiple microlayers each of which is not continuous around the hydro-soluble component, but each layer overlaps to completely cover the feed or feed additive.

The presence of microlayers can be determined by techniques known to those skilled in the art. For instance scanning electron microscopy (SEM) can be used to visualise the layers. This technique would be familiar to the skilled person and involves freezing a sample in liquid nitrogen and fracturing the particles to reveal the interior structure of the coating. An alternative technique is oil-immersion microscopy.

Microlayers in the coating may be provided by hot melt coating the feed or feed additive with a hardened fat. Hot melt coating is a technique familiar to the skilled person further details of which can be found in “Single-Core Encapsulation: Film Coating” Chapter 5, Charles R. Frey and Harlan S. Hall, pages 83-101 in Microencapsulation of Food Ingredients, Ed. Per Vilstrup, 2001 Leatherhead Publishing, LFRA Ltd and “Fluidized bed coating in food technology”, K. Dewettinck* and A. Huyghebaert, Trends in Food Science & Technology 10 (1999) pages 163-168.

In another aspect, the present invention relates to a composition comprising a coated feed or feed additive obtainable by a process comprising hot melt coating a feed additive with a hardened fat.

Preferably, the hardened fat referred to above is as previously defined.

In another aspect, the present invention relates to a composition comprising a feed or feed additive coated with a coating substance wherein the feed or feed additive and the coating substance form a core, and wherein the core is coated with a further coating substance.

The further coating substance may or may not the same as the coating substance which coats the feed or feed additive.

In one embodiment, the further coating substance is the same as the coating substance which coats the feed or additive.

In another embodiment, the further coating substance and the coating substance which coats the feed or feed additive may be independently selected from the coating substances previously defined herein.

### Process for Preparation

In another aspect, the present invention relates to a process for preparation of a composition as defined above, said process comprising coating a feed or feed additive as defined above with a coating substance as defined above.

In one embodiment, coating is achieved by coating a feed or feed additive (as defined above) with a coating substance (as defined above) by a process comprising at least one of a hot melt coating, a spray-cooling or a hot melt extrusion step.

Preferably, coating is achieved by coating a feed or feed additive (as defined above) with a coating substance (as defined above) by a process comprising hot melt coating using a fluid bed.

In one embodiment, coating is achieved by coating a feed or feed additive (as defined above) with a coating substance (as defined above) by a process comprising two process steps selected from hot melt coating, spray-cooling or hot melt extrusion.

In one embodiment, coating is achieved by a combination of hot melt coating and spray-cooling. Preferably, coating is achieved by first spray-cooling the feed or feed additive (as defined above) with a coating substance (as defined above) followed by hot melting coating the resultant material using a fluid bed.

### Use/Methods

Rumen fermentation brings some disadvantages. Methane is produced as a natural consequence of the anaerobic fermentation, which represents an energy loss to the host animal.

Carbohydrate makes up 70-80% of the dry matter in a typical dairy cattle ration, and in spite of this, the absorption of carbohydrates from the gastrointestinal tract is normally very limited.

The reason for this is the extensive fermentation of carbohydrates in the rumen resulting in the production of acetate, propionate and butyrate as the main products. These products are part of the so called volatile fatty acids, (VFAs).

Besides the energy loss, methane is also a greenhouse gas, which is many times more potent than CO₂.

Between 1750 and 1998 atmospheric methane increased by 149% from 700 to 1745 parts per billion. It is estimated that 55-70% of methane emissions are from anthropogenic activities and that 20-25% of these emissions are from ruminant eructation. There is a strong relationship between the increase in atmospheric methane concentrations and global ruminant populations. Not only does methanogenesis in ruminants increase greenhouse gas emissions, but it is also energetically wasteful to the animal resulting in a loss of 2 to 12% ingested feed energy. Therefore reducing methanogenesis in ruminants will not only reduce greenhouse gas emissions, but also increase feed efficiency in the animal.

By coating feed or feed additives as described above, the present inventors have found that it is possible to reduce the production of methane emanating from the digestive activities of ruminants without negatively affecting total VFA production.

In another aspect, the present invention relates to use of a composition comprising a feed or feed additive and a coating substance, wherein the feed or feed additive is coated with the coating substance, for improving milk yield in lactating ruminants.

In another aspect, the present invention relates a method for improving the milk yield of ruminants comprising administering a composition as described herein to lactating ruminants.

Certain feeds or feed additives may be useful for improving milk yield in lactating ruminants.

An increased concentration of propionic acid in the rumen has a positive effect on milk yield (Rigout, S., Hurtaud C., Lemosquet S., and. Rulquin H., Lactational effect of propionic acid and duodenal glucose in cows; Journal of Dairy Sciences, 86: 243-253, 2003). Decreased ratio of propionic to acetic or propionic to butyric may lead to ketogenesis leading to higher fat content but lower milk yield. Increased propionic acid production can counteract ketogenesis, and protect the animal from negative metabolic effects while increasing milk yield.

In one embodiment, the feed or feed additive is as previously defined.

In one embodiment, the coating substance is as previously defined.

In another aspect, the present invention relates to use of a composition comprising a feed or feed additive and a coating substance, wherein the feed or feed additive is coated with the coating substance, for reducing methane production by ruminants.

In another aspect, the present invention relates to use of a composition comprising a feed or feed additive and a coating substance, wherein the feed or feed additive is coated with the coating substance, for reducing global warming.

In another aspect, the present invention relates to a method for reducing global warming comprising administering a composition as described herein to ruminants.

Methane emission by ruminants can easily be measured in individual animals in metabolic chambers by methods known in the art (Grainger et al., 2007 J. Dairy Science; 90: 2755-2766). Moreover, it can also be assessed at barn level by an emerging technology using laser beam (McGinn et al., 2009, Journal of Environmental Quality; 38: 1796-1802). Alternatively, methane produced by a dairy ruminant can also be assessed by measurement of VFA profiles in milk according to WO 2009/156453.

Ruminant performance can be assessed by methods well known in the art, and is usually characterized by feed conversion ratio, feed intake, weight gain, carcass yield, or milk yield.

### Animal Feed

As used herein the term ‘animal feed composition’ has the normal meaning attributed to it in the art. For instance, an animal feed may be considered a mixture of components useful in ruminant nutrition which is fed to ruminants.

Animal feed compositions are usually comprised of an easily degradable fraction (named concentrate) and a fiber-rich less readily degradable fraction (named roughage).

In one embodiment, the animal feed composition includes a source of roughage (fibrous material).

Roughage materials may include without limitation one or more of the following: Almond Hulls, Psyllium Seed Husk, Dried Apple Pectin Pulp, Malt Hulls, Dried Apple Pomace, Clipped Oat By-Product, Bagasse, Oat Hulls, Barley Hulls, Oat Mill By-Product, Barley Mill By-Product, Peanut Hulls, Dried, Plain Beet Pulp, Rice Hulls, Buckwheat Hulls, Rice Mill By-Product, Dried Citrus Meal, Rye Mill Run, Dried Citrus Pulp, Soybean Hulls, Citrus Seed Meal, Soybean Mill Feed, Coin Cob Fractions, Soybean Mill Run, Cottonseed Hulls, Sunflower Hulls, Flax Straw By-Product, Ground Straw, Ground Corn Cob, Dried Tomato Pomace.

Roughage may be from grain and usually consists of the outer covering of the grain but may include other parts of the grain generated during the grain milling process. Examples of roughage preferred in the present invention include, rice hulls, soybean hulls, oat hulls, corn cob fractions, ground corn cob, wheat bran, and the like.

In one embodiment, the animal feed composition may comprise a plant material, such as grasses or legumes. Grasses include among others timothy, ryegrasses, and fescues. Legumes include among others clover, lucerne or alfalfa, peas, beans and vetches. Whole cereals include among others barley, maize (corn), oat, sorghum. Other forage crops include sugarcane, kales, rapes, and cabbages. Also root crops such as turnips, swedes, mangles, fodder beet, and sugar beet (including sugar beet pulp and beet molasses) are used to feed ruminants. Still further crops are tubers such as potatoes, cassava and sweet potato.

In a preferred embodiment the animal feed composition comprises dry grasses, such as hay, and grasses in a preserved state, such as silage. Silage is an ensiled version of the fiber-rich fraction (e.g. from grasses, legumes or whole cereals) whereby material with a high water content is treated with a controlled anaerobic fermentation process (naturally-fermented or additive treated).

Concentrate is largely made up of cereals (such as barley including brewers grain and distillers grain, maize, wheat, sorghum), but also often contain protein-rich feed ingredients such as soybean, rapeseed, palm kernel, cotton seed and sunflower.

In one embodiment, the animal feed composition may comprise further components commonly used in ruminant nutrition. For example sweeteners, such as molasses and honey.

In one embodiment, the ratio of roughage to concentrate (F/C ratio) is preferably about 60/40.

In one embodiment, the feed or feed additive is present in the animal feed composition in a concentration of up to 2% w/w. Preferably, up to 1.5% w/w. More preferably up to 1% w/w. More preferably, up to 0.5% w/w.

The invention will now be further described by the following examples which should not be considered to limit the scope of the invention.

### EXAMPLES

### Preparative Example 1

This sample was prepared by spray-drying betaine with hydroxypropylmethyl cellulose (Methocel SGA7C) and an inert filler. Without being bound by theory, HPMC gels in aqueous solution which is believed to reduce diffusion of the betaine through the particle matrix; Methocel SGA7C gels between 30-45° C. The inclusion of an inert filler aims to reduce the payload of the sample and thus reduce the rate of diffusion of betaine.

0.25 kg of HPMC (Methocel SGA150; Dow Chemical Company) was dry-blended with 0.5 kg of betaine (Betafin BT; Finn Feeds) and dispersed in 5 kg cold tap water, using a Silverson homogenizer. 0.4 kg of further Betafin BT and 0.5 kg of Calcium Hydrogen Phosphate, Dihydrate (Chemische Fabrik Budenheim KG) was added to the solution with constant agitation. The suspension was fed to into a Niro 6,3 spray tower under the following conditions:

| Parameter | Setting |
|---|---|
| Atomising Device | Wheel |
| Rotation Speed (rpm) | 8000-10000 |
| Drying inlet air temperature (° C.) | 210-230 |
| Drying outlet air temperature (° C.) | 90-110 |
| Drying air flow (m³hr⁻¹) | 450-550 |

### Preparative Example 2

This sample was prepared by spray-cooling betaine with a suitable lipid followed by a second coating in a fluid bed.

2 kg of betaine (Betafin BT; Finn Feeds) was milled through a Retsch SK100 rotor mill (Plate 15) and added to 3 kg of fully hardened rapeseed oil, held at 90-110° C. and homogenized at high speed with a Silverson mixer. The slurry was atomized into a Niro 6,3 spray tower under the following conditions:

| Parameter | Setting |
|---|---|
| Atomising Device | Wheel |
| Rotation Speed (rpm) | 5500-6500 |
| Cooling air temperature (° C.) | 5-15 |
| Cooling air flow (m³hr⁻¹) | 500-600 |
| Feed temperature (° C.) | 70-80 |

The finished intermediate was sieved through a 1000 μm sieve to remove aggregates.

1.6 kg of the finished intermediate from above (fraction 125-500 μm) was fluidized in a GEA Aeromatic MP1 fluid bed, operating in top-spray mode. The bed was equipped with a Schlick series 970 nozzle connected to a Watson Marlow pump by 3.2 mm electrically traced silicone hose. The coating material, fully hardened rapeseed oil, was held at an elevated temperature in an oil-bath. 0.4 kg of coating material was atomized onto the fluidized intermediate particles under the following conditions:

| Parameter | Setting |
|---|---|
| Bed temperature (° C.) | 53-57 |
| Inlet Air temperature (° C.) | 55-70 |
| Air flow rate (m³hr⁻¹) | 45-70 |
| Melt temperature (° C.) | 120-140 |
| Atomising Air pressure (bar) | 1.4-2.0 |
| Coating rate (kghr⁻¹) | 0.4-0.8 |

The finished product was sieved through 1500 μm sieve to remove aggregates.

### Preparative Example 3 (B52)

This sample was prepared by hot-melt coating with fully hardened palm oil.

1.85 kg of Betain BT (Finn Feeds) was fluidized in a GEA Aeromatic MP1 fluid bed, operating in top-spray mode. The bed was equipped with a Schlick series 970 nozzle connected to a Watson Marlow pump by 3.2 mm electrically traced silicone hose. The coating material, fully hardened palm oil, was held at an elevated temperature (110° C.) in an oil-bath. 1,235 kg coating material was atomized onto the fluidized Betafin BT particles under the following conditions:

| Parameter | Setting |
|---|---|
| Bed temperature (° C.) | 44-46 |
| Inlet Air temperature (° C.) | 40-50 |
| Air flow rate (m³hr⁻¹) | 80-90 |
| Melt temperature (° C.) | 110 |
| Atomising Air pressure (bar) | 1.6-2.0 |
| Coating rate (kghr⁻¹) | 1.0 |

The finished product was sieved through 1500 μm sieve to remove aggregates.

### Preparative Example 4 (B60)

This sample was prepared by a combination of hot-melt extrusion and milling. The matrix was a mixture of ethylcellulose and Acetem (as plasticizer). Ethylcellulose is insoluble in water and was used to provide the scaffold of the particles, with the incorporated betaine providing the erodible content.

1 kg of Acetem 70-00 (DuPont) was heated to 60° C. and plated onto 4 kg ethylcellulose (Ethocel Standard 7 Premium; Dow Chemical Company) in a bowl chopper to create a homogenenous coating blend. Betaine (Betafin BT; Finn Feeds) was milled in a Retsch SK Rotor Mill (plate 15). The coating blend and Betafin BT were fed individually into the Clextral BC 45 co-rotating twin-screw extruder, using screw feeders with feed-rates of both streams varying from 4-5 kg/hr. The extruder was equipped with a 0.8 mm die plate. Temperature across the extruder was held constant at 150° C., except for the die plate, which was held at 90° C. Under production, pressure at the die plate varied from 20-40 bar. The extrudate was collected on a conveyor belt, cooled and then milled (Restch SK 100 Rotor Mill, plate 15) to produce the finished product.

### Preparative Example 5

This sample was prepared by spraying an aqueous film coating on betaine in a fluid bed.

A coating solution was prepared contained 300 g of a high molecular weight polyvinylalcohol (Mowial 18-88 from Kuraray), 140 g talc (Imerys Talc) and 25 g of lecithin (Solec CST 35 from DuPont, dissolved in 25 g of ethanol). The coating solution was further diluted with 500 g of cold water, maintained at ambient temperature and stirred constantly during spraying. 1.85 kg of Betain BT (Finn Feeds) was fluidized in a GEA Aeromatic MP1 fluid bed, operating in top-spray mode. The bed was equipped with a Schlick series 970 nozzle connected to a Watson Marlow pump by 3.2 mm silicone hose. 1,397 g of coating solution was atomised onto the Betafin BT under the following conditions:

| Parameter | Setting |
|---|---|
| Bed temperature (° C.) | 46-49 |
| Inlet Air temperature (° C.) | 50-59 |
| Air flow rate (m³hr⁻¹) | 70-100 |
| Coating temperature (° C.) | Ambient |
| Atomising Air pressure (bar) | 2.2 |
| Atomising Air temperature (° C.) | 25 |
| Coating rate (kghr⁻¹) | 0.25-0.45 |

500 g in-process samples were removed at coating amounts equivalent to 5% and 10% coating. The finished product was sieved through 1500 μm sieve to remove aggregates.

### Preparative Example 6A and 6B

These samples were prepared by spray-drying betaine with a fully hydrolysed polyvinylalcohol.

1.41 kg of Betafin BT was dissolved in 0.94 kg of deionized water. 0.25 kg of polyvinylalcohol (6A: Poval 4-98 from Kururay or 6B: Selvol 103 from Seksui) was slowly added to 0.94 kg/1.25 kg of deionized water and heated, under agitation to 95° C. for 15 minutes. The 60% betaine solution was added to the hot polyvinylalcohol solution to give a feed solution with solids content of 43-50% (of which 85% was Betafin BT and 15% was polyvinylalcohol). The feed solution was atomized into a NIRO NP 6.3 spray unit, using a spray wheel (120 mm diameter) with co-current airflow (600 m³ hr⁻¹). Wheel speed was 14000-15000 rpm; inlet air temperature 196-203° C., feed rate 52-55 kghr⁻¹ and outlet air temperature 102-111° C. A fine brown powder was collect from the rotary cell with mass yields between 52% (Poval 4-98) and 89% (Selvol E103).

### In Vitro Study

### Design

Twelve mature Murciano-Granadina goats of similar body weight (46.97±2.5 kg BW) during late lactation were randomly split into 4 groups. Each group was fed with the same total mixed ration for 10 days. Each group included 4 g/kg of one of four types of betaine additive:
1—Non Coated Betaine BS1 (Betafin S1, natural betaine, DuPont)
2—Coated Betaine B52 (see preparative example 3)
3—Coated Betaine B60 (see preparative example 4)
4—Uncoated Betaine HCl

After an adaptation period to the diets including betaine of 10 days, ruminal fluid was obtained by means of an oesophagus probe from all goats. Ruminal fluid from goats (3 per treatment) was obtained just before feeding, transported to the laboratory and immediately strained/filtered across/through four layers of cheesecloth and mixed into an Erlenmeyer flask.

The in vitro fermentation was carried out by the following incubation process; the squeezed rumen fluid (after filtration) was mixed with Goering and Van Soest (1970) buffer solution in a 1:4 (v/v) ratio at 39° C. under continuous flow of CO₂.

Samples of 1 g of total ration (0.4 g concentrate and 0.6 g alfalfa hay) plus betaine (0.015 g of each type) were accurately weighed and mixed into 125 mL bottles (ANKOM RF equipment). 50 mL of the buffered rumen fluid was added to each bottle under CO₂ flow.

Bottles were sealed and incubated at 39° C. for 24 h. Gas measurements were recorded every hour, while pH was measured at the start and right after 24 h; crude fiber, digestibility, CH₄ and volatile fatty acid (VFA) concentrations were determined after 24 h of incubation.

### Diet

Alfalfa hay was used as roughage (F) while a concentrate and a premix (C) were mixed and pelleted.

The ratio F/C was 60/40 with C high in corn and starch. Diets were isoenergetic with an average value of 17.5 MJ/kg DM (GE), 43% of starch and 10% NDF. Nutrient requirements used in this trial followed both Lachica and Aguilera (2003) and FEDNA (2009) guidelines. Daily ration was offered in two: at 08:00 and 16:00 h, respectively. Goats had free access to water during the trial.

| Ingredients | % |
|---|---|
| Corn | 64.71 |
| Soybean 44 | 28.43 |
| Wheat Bran | 2.55 |
| Dehydrated alfalfa | 1.88 |
| Calcium carbonate | 1.50 |
| Molasses | 0.20 |
| Salt | 0.33 |
| Premix | 0.40 |

Chemical composition (%)

| Dry matter | | | 86.56 | | |
|---|---|---|---|---|---|
| UFL | | | 1.03 | | |
| CP | | | 17.9 | | |
| PDIA | | | 7.78 | | |
| PDIN | | | 13.17 | | |
| PDIE | | | 12.17 | | |
| EE | | | 2.83 | | |
| NDF | | | 10.74 | | |
| Starch | | | 43.0 | | |
| P total | | | 0.36 | | |
| Na | | | 0.13 | | |
| Cl | | | 0.25 | | |
| Lys | 0.98 | Met | 0.29 | M + C | 0.62 |

| | |
|---|---|
| Sugars | 3.54 |

### Results:

### Parameters:

Ruminal parameters (Dry matter DM, Ruminal liquor pH, DM digestibility, N—NH₃)
Determination of Volatile Fatty Acids (VFA)
Gas production (Methane content CH4)

TABLE 1
Ruminal parameters after 24 hrs of incubation

| | B52 | B60 | BHCl | BS1 | P-value |
|---|---|---|---|---|---|
| S, g DM | 0.945 | 0.944 | 0.963 | 0.956 | 0.144 |
| Ruminal liquor pH | | | | | |
| Initial liquor | 6.68 | 6.68 | 6.71 | 6.77 | 0.420 |
| Initial liquor + | 6.97 | 6.97 | 6.89 | 6.92 | 0.078 |
| buffer | | | | | |
| Liquid + buffer + S, | 6.84 | 6.82 | 6.92 | 7.04 | 0.156 |
| after 24 h incubation | | | | | |
| Residue | | | | | |
| R, g DM | 2.24^{a} | 2.20^{a} | 2.06^{b} | 2.02^{b} | 0.057 |
| % difference vs. | (+8.73%) | (+6.79%) | | | |
| B•HCl | | | | | |
| % difference vs. | (+10.9%) | (+8.91%) | | | |
| BS1 | | | | | |
| R/S | 2.37^{a} | 2.34^{a} | 2.13^{b} | 2.12^{b} | 0.032 |
| % difference vs. | (+11.3%) | (+9.86%) | | | |
| B•HCl | | | | | |
| % difference vs. | (+11.8%) | (+10.4%) | | | |
| BS1 | | | | | |
| R-NDF, % DM | 12.16^{b} | 12.34^{ab} | 12.91^{ab} | 13.33^{a} | 0.157 |
| | (−8.77%) | | | | |
| R-NDF/S | 12.87 | 13.12 | 13.40 | 13.93 | 0.237 |
| DM digestibility, % | 75.14 | 75.01 | 75.69 | 75.09 | 0.862 |
| N—NH₃, mg/L | 41.86 | 41.91 | 51.13 | 45.04 | 0.853 |

S = substrate or sample (roughage + concentrate + Betaine);
R = residue after 24 h of incubation;
R-NDF = neutral detergent fiber from the residue;
N—NH₃ = ammonia nitrogen;
Levels not connected by the same letter are significantly different (P < 0.05)

After 24 h of incubation, no significant differences were observed among different types of betaine (uncoated Betafin, coated Betafin B52 and B60 and uncoated betaine HCl) in terms of substrate degradability, digestibility and protein degradation at 24 h of incubation.

Betaine HCl has the same behaviour as Betafin except for N—NH₃ production where the Betafin samples (coated and uncoated) tend to lead to lower N—NH₃ production.

However, coated Betafin samples (B52 and B60) significantly increase the dry matter of Residue (R) as well as the R/S ratio after 24 h of incubation when compared with uncoated Betafin or Betaine HCl. This indicates that the overall amount of substrate degraded was decreased.

TABLE 2
Determination of Volatile Fatty Acids (VFA)
production after 24 h of incubation

| | B52 | B60 | BHCl | BS1 | P-value |
|---|---|---|---|---|---|
| Total VFA, mmol/L | 45.89 | 43.99 | 47.13 | 43.46 | 0.826 |
| Acetic acid | 63.95 | 63.08 | 63.90 | 63.92 | 0.955 |
| Propionic acid | 23.52^{a} | 24.07^{a} | 18.07^{b} | 17.92^{b} | 0.001 |
| % difference vs. | (+30.2%) | (+33.2%) | | | |
| B•HCl | | | | | |
| % difference vs. | (+31.3%) | (+34.3%) | | | |
| BS1 | | | | | |
| Isobutyric acid | 0.62 | 0.68 | 0.61 | 0.51 | 0.675 |
| Butyric acid | 9.44^{b} | 9.62^{b} | 14.63^{a} | 15.26^{a} | 0.001 |
| % difference vs. | (−35.5%) | (−34.2%) | | | |
| B•HCl | | | | | |
| % difference vs. | (−38.1%) | (−36.9%) | | | |
| BS1 | | | | | |
| Isovaleric acid | 0.90 | 0.96 | 0.95 | 0.66 | 0.827 |
| N-Valeric acid | 1.49 | 1.51 | 1.64 | 1.55 | 0.677 |
| N-Caproic acid | 0.16 | 0.17 | 0.19 | 0.18 | 0.666 |

Levels not connected by the same letter are significantly different (P < 0.05)

After 24 h of incubation, no significant differences were observed among different types of betaine in terms of the amounts of acetic acid, isovaleric acid and caproic acid.

Major differences appear with total VFA where Betafin samples (coated and uncoated) tend to reduce total VFA production.

Furthermore, coated Betafin samples (B52 and B60) significantly increase the production of propionic acid with average improvement of >32% compared with uncoated betaine HCl and uncoated Betafin.

At the same time, coated Betafin samples (B52 and B60) significantly decrease the production of butyric acid with average reduction of >36% compared with uncoated betaine HCl and uncoated Betafin.

The results suggest a use in milk production and energy sourcing. Indeed, in ruminants, most of the acetate and all the propionate are transported to the liver, but the majority of butyrate is converted in the rumen wall to a ketone body called β-hydroxybutyrate. Ketones are important sources of energy (fuel for combustion) for most tissues in the body. Ketones come primarily from the butyrate produced in the rumen, but in early lactation, they also come from the mobilization of adipose tissue (Wattiaux M. and Armentano L. E. 2011. Carbohydrate metabolism in dairy cows; chapter from Dairy Essentials Collection—Nutrition and feeding. University of Wisconsin, Madison).

TABLE 3
Gas production (Methane content CH₄) after 24 hrs of incubation

| | B52 | B60 | BHCl | BS1 | P-value |
|---|---|---|---|---|---|
| Gas production, mL | 204.06 | 212.44 | 210.67 | 203.41 | 0.4737 |
| mL gas/S | 216.04 | 225.16 | 218.70 | 210.33 | 0.349 |
| mL CH₄ | 11.03^{a} | 8.86^{b} | 10.68^{a} | 12.17^{a} | 0.045 |
| % difference vs. | | (−17.0%) | | | |
| B•HCl | | | | | |
| % difference vs. BS1 | | (−27.19%) | | | |
| mL CH₄/S | 11.68^{a} | 9.39^{b} | 11.10^{a} | 12.65^{a} | 0.049 |
| % difference vs. | | (−15.4%) | | | |
| B•HCl | | | | | |
| % difference vs. BS1 | | (−25.77%) | | | |
| CH₄/S, J | 460.12 | 369.97 | 437.48 | 498.54 | 0.367 |

1J = 4.18 calories;
S = substrate in g DM;
Levels not connected by the same letter are significantly different (P < 0.05)

After 24 h of incubation, no significant differences were observed among different types of betaine in total amount of gas production.

Major differences appear with CH₄ production where coated Betafin (especially B60) significantly reduces the production of methane with average reduction of >20% compared with uncoated betaine HCl and uncoated Betafin.

From this in vitro study with various betaines, it appears that coated samples (B52 and B60) when added to an animal feed, offered positive protection against ruminal microbes and degradation; the VFA fermentation profile as well as methane and ammonia reduction support this observation.

The subject matter of the application will now be further described in the following numbered paragraphs:

1. A composition comprising a feed or feed additive and a coating substance, wherein the feed or feed additive is coated with the coating substance, wherein the coating substance decreases the degree of degradation of the feed or feed additive within the rumen environment.

2. A composition according to any preceding paragraph wherein the feed or feed additive is selected from betaine, direct fed microbials, enzymes, essential oils, organic acids, vitamins, amino acids and minerals.

3. A composition according to any preceding paragraphs wherein the feed or feed additive comprises betaine or an animal feed acceptable salt or hydrate thereof.

4. A composition according to any preceding paragraph wherein the coating substance comprises a lipid, an emulsifier or a polymer.

5. A composition according to any preceding paragraph wherein the coating substance comprises hardened vegetable fats and oils, fatty acid monoglycerides, diglycerides and triglycerides, free fatty acids, waxes, natural and synthetic resins, polymers, or emulsifiers.

6 A composition according to any preceding paragraphs wherein the coating substance comprises an emulsifier selected from fatty acid monoglycerides, diglycerides, polyglycerol esters and sorbitan esters of fatty acids.

7. A composition according to any preceding paragraph wherein the coating substance comprises a polymer selected from a water soluble polymer (such as polyvinylalcohol), or a film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixture thereof.

8. A composition according to any preceding paragraph wherein the coating substance comprises a polymer selected from film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixtures thereof.

9. A composition according to any preceding paragraph wherein the coating substances comprises a polymer wherein said polymer comprises polyvinylalcohol.

10. A composition according to any preceding paragraph wherein the coating substance comprises a polymer which is a polyvinylalcohol.

11. A composition according to any preceding paragraph wherein the polyvinylalcohol is a fully hydrolysed polyvinylalcohol.

12. A composition according to any preceding paragraph wherein the polyvinylalcohol is a high molecular weight polyvinylalcohol.

13. A composition according to any preceding paragraph wherein the coating substance comprises a lipid selected from animal oils or fats, vegetable oils or fats, triglycerides, free fatty acids, animal waxes, (such as beeswax, lanolin, shell wax or Chinese insect wax), vegetable waxes (such as carnauba, candelilla, bayberry or sugarcane), mineral waxes, synthetic waxes, natural and synthetic resins and mixtures thereof.

14. A composition according to any preceding paragraph wherein the coating substance comprises a lipid selected from hardened vegetable oils or fats, triglycerides, and mixtures thereof.

15. A composition according to any preceding paragraph wherein the coating substance comprises a fat.

16. A composition according to any preceding paragraph wherein the coating substance comprises a fat which has a melting point of about 40° C. to about 80° C.

17. A composition according to any preceding paragraph wherein the coating substance comprises a fat which is a fully hardened fat.

18. A composition according to any preceding paragraph wherein the coating substance comprises a fat which is comprised of triglycerides.

19. A composition according to any preceding paragraph wherein the coating substance comprises a fat which is comprised of triglycerides having a C14, C16 and C18 fatty acid chain length, and mixtures thereof.

20. A composition according to any preceding paragraph wherein the coating substance comprises a fat selected from canola oil, cottonseed oil, peanut oil, corn oil, olive oil, soybean oil, sunflower oil, safflower oil, coconut oil, palm oil, linseed oil, tung oil, castor oil and rapeseed oil.

21. A composition according to any preceding paragraph wherein the coating substance is selected from ethylcellulose, HMPC, alginate, fully hardened palm oil, fully hardened rapeseed oil, fully hardened cottonseed oil and fully hardened soybean oil.

22. A composition according to any preceding paragraph wherein the coating substance comprises one or more of the following: ethylcellulose, HMPC, polyvinylalcohol, carageenan, sodium alginate, fully hardened palm oil, fully hardened rapeseed oil, fully hardened cottonseed oil and fully hardened soybean oil.

23. A composition according to any preceding paragraph wherein the coating substance comprises microlayers.

24. A composition according to any preceding paragraph wherein the feed or feed additive and the coating substance form a core, and wherein the core is coated with a further coating substance.

25. A composition according to any preceding paragraph wherein the degree of degradation is decreased such that there is between about 1% and about 30% increase in the amount of residual feed or feed additive per gram of initial feed or feed additive (calculated on a dry matter basis).

26. A composition according to any preceding paragraph wherein the degree of degradation is decreased such that there is at least a 5% decrease in the amount of CH₄ produced within 24 hours per gram of feed or feed additive (dry matter basis).

27. A composition according to any preceding paragraph wherein the degree of degradation of the feed or feed additive within the rumen environment is determined by an assay method comprising adding a sample (1 g) of composition according to any preceding paragraph to filtered ruminal fluid mixed with Goering and Van Soest (1970) buffer solution in a 1:4 (v/v) ratio (50 ml), and sealing under CO₂ flow, then incubating at 39° C. for 24 hours.

28. Use of a composition comprising a feed or feed additive and a coating substance, wherein the feed or feed additive is coated with the coating substance, for reducing degradation of the feed or feed additive within the rumen environment.

29. Use of a coating substance in a composition comprising a feed or feed additive and the coating substance, wherein the feed or feed additive is coated with the coating substance, for reducing degradation of the feed or feed additive within the rumen environment.

30. Use of a composition comprising a feed or feed additive and a coating substance, wherein the feed or feed additive is coated with the coating substance, for improving milk yield in lactating ruminants.

31. Use of a composition comprising a feed or feed additive and a coating substance, wherein the feed or feed additive is coated with the coating substance, for reducing methane production by ruminants.

32. Use of a composition comprising a feed or feed additive and a coating substance, wherein the feed or feed additive is coated with the coating substance, for reducing global warming.

33. Use according to any preceding paragraph wherein the feed or feed additive is selected from betaine, direct fed microbials, enzymes, essential oils, organic acids, vitamins, amino acids and minerals.

34. Use according to any preceding paragraph wherein the feed or feed additive comprises betaine or an animal feed acceptable salt or hydrate thereof.

35. Use according to any preceding paragraph wherein the coating substance comprises a lipid, an emulsifier or a polymer.

36. Use according to any preceding paragraphs wherein the coating substance comprises an emulsifier selected from polyglycerol esters, sorbitan esters of fatty acids, animal waxes, such as beeswax, lanolin, shell wax or Chinese insect wax.

37. Use according to any preceding paragraph wherein the coating substance comprises a polymer selected from film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixtures thereof.

38. Use according to any preceding paragraph wherein the coating substance comprises a lipid selected from animal oils or fats, vegetable oils or fats, triglycerides, free fatty acids, animal waxes, (such as beeswax, lanolin, shell wax or Chinese insect wax), vegetable waxes (such as carnauba, candelilla, bayberry or sugarcane), mineral waxes, synthetic waxes, natural and synthetic resins and mixtures thereof.

39. Use according to any preceding paragraph wherein the coating substance comprises a lipid selected from hardened vegetable oils or fats, triglycerides, and mixtures thereof.

40. Use according to any preceding paragraph wherein the coating substance comprises a fat.

41. Use according to any preceding paragraph wherein the coating substance comprises a fat which has a melting point of about 40° C. to about 80° C.

42. Use according to any preceding paragraph wherein the coating substance comprises a fat which is a fully hardened fat.

43. Use according to any preceding paragraph wherein the coating substance comprises a fat which is comprised of triglycerides.

44. Use according to any preceding paragraph wherein the coating substance comprises a fat which is comprised of triglycerides having a C14, C16 and C18 fatty acid chain length, and mixtures thereof.

45. Use according to any preceding paragraph wherein the coating substance comprises a fat canola oil, cottonseed oil, peanut oil, corn oil, olive oil, soybean oil, sunflower oil, safflower oil, coconut oil, palm oil, linseed oil, tung oil, castor oil and rapeseed oil.

46. Use according to any preceding paragraph wherein the coating substance is selected from ethylcellulose, HMPC, alginate, fully hardened palm oil, fully hardened rapeseed oil, fully hardened cottonseed oil and fully hardened soybean oil.

47. Use according to any preceding paragraph wherein the coating substance comprises microlayers.

48. Use according to any preceding paragraph wherein the feed or feed additive and the coating substance form a core, and wherein the core is coated with a further coating substance.

49. A method for reducing the degree of degradation of a feed or feed additive in the rumen environment comprising administering a composition according to any preceding paragraph to ruminants.

50. A method for improving the milk yield of ruminants comprising administering a composition according to any preceding paragraph to lactating ruminants.

51. A method for reducing global warming comprising administering a composition according to any preceding paragraph to ruminants.

52. A feed or feed additive wherein the feed or feed additive is coated with a coating substance wherein the coating substance comprises microlayers of triglyceride.

53. A coated feed or feed additive obtainable by a process comprising hot melt coating a feed or feed additive with a lipid.

54. A composition comprising a feed or feed additive coated with a coating substance wherein the feed or feed additive and the coating substance form a core, and wherein the core is coated with a further coating substance.

55. An animal feed composition comprising a composition according to any preceding paragraph.

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the claims appended hereto as permitted by applicable law.

1-23. (canceled)

24. A composition comprising a feed or feed additive and a coating substance, wherein the feed or feed additive is coated with the coating substance selected from hardened vegetable fats and oils, fatty acid monoglycerides, diglycerides and triglycerides, free fatty acids, waxes, natural and synthetic resins, polymers, emulsifiers and mixtures thereof, and wherein the coating substance decreases the degree of degradation of the feed or feed additive within the rumen environment.

25. The composition of claim 24 wherein the feed or feed additive is selected from betaine, direct fed microbials, enzymes, essential oils, organic acids, vitamins, amino acids and minerals.

26. The composition of claim 24 wherein the feed or feed additive comprises betaine or an animal feed acceptable salt or hydrate thereof.

27. The composition of claim 24, 25 or 26 wherein the coating substance comprises a polymer selected from film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixtures thereof.

28. The composition of claim 24 wherein the coating substance comprises a hardened fat which has a melting point of about 40° C. to about 80° C.

29. The composition of claim 24 wherein the coating substance comprises a hardened fat which is a fully hardened fat.

30. The composition of claim 28 or 29 wherein the coating substance comprises a hardened fat which is comprised of triglycerides.

31. The composition of claim 30 wherein the coating substance comprises a hardened fat which is comprised of triglycerides having a C14, C16 and C18 fatty acid chain length, and mixtures thereof.

32. The composition of claim 29 wherein the coating substance comprises a hardened fat selected from fully hardened canola oil, fully hardened cottonseed oil, fully hardened peanut oil, fully hardened corn oil, fully hardened olive oil, fully hardened soybean oil, fully hardened sunflower oil, fully hardened safflower oil, fully hardened coconut oil, fully hardened palm oil, fully hardened linseed oil, fully hardened tung oil, fully hardened castor oil and fully hardened rapeseed oil.

33. The composition of claim 24 wherein the coating substance is selected from ethylcellulose, HMPC, alginate, fully hardened palm oil, fully hardened rapeseed oil, fully hardened cottonseed oil and fully hardened soybean oil.

34. The composition of claim 24 wherein the coating substance comprises a polyvinylalcohol.

35. The composition of claim 24 wherein the coating substance comprises microlayers.

36. The composition of claim 24, 25 or 26 wherein the feed or feed additive and the coating substance form a core, and wherein the core is coated with a further coating substance.

37. A method for reducing the degree of degradation of a feed or feed additive in a rumen environment comprising administering a composition as defined in any one of claim 24, 25 or 26 to ruminants.

38. A method for improving the milk yield of ruminants comprising administering the composition of claim 24 to lactating ruminants.

39. A method for reducing global warming comprising administering a composition as defined claim 24 to ruminants.

40. A feed or feed additive wherein the feed or feed additive is coated with a coating substance wherein the coating substance comprises microlayers of a hardened fat.

41. A coated feed or feed additive obtainable by a process comprising hot melt coating a feed or feed additive with a hardened fat.

42. An animal feed composition comprising the composition of claim 24.
